(19) United States
(12) Patent Application Publication
(10) Pub. No.: US 2015/0324279 A1
(43) Pub. Date: Nov. 12, 2015

(54) HYBRID MEMORY TABLE CLUSTER SYSTEM

(71) Applicant: Altibase Corp., Seoul (KR)

(72) Inventors: Hyung Sung Lee, Bucheon-si (KR); Kwang Ik Seo, Incheon (KR)

(21) Appl. No.: 14/706,584

(22) Filed: May 7, 2015

(30) Foreign Application Priority Data
May 8, 2014 (KR) 10-2014-0054930
Dec. 2, 2014 (KR) 10-2014-0170740
Apr. 21, 2015 (KR) 10-2015-0056000

(51) Int. Cl. G06F 12/02; G06F 17/30

(52) U.S. Cl. CPC G06F 12/023; G06F 17/30289; G06F 2212/251

(57) ABSTRACT

A memory cluster system includes a shared storage, a plurality of nodes configured to share the shared storage, and a controller configured to allocate data to be loaded by each node to each main memory of each of the plurality of nodes and used by using a memory pointer when a database management system (DBMS) is starting up, from among data in the shared storage, to a main memory of each of the plurality of nodes based on a capacity of each main memory of the plurality of nodes, wherein each main memory of the plurality of nodes includes: a local memory storage configured to load data from all memory tables and all memory indexes to the main memory of each of the plurality of nodes when the DBMS is starting up; and a remote memory storage configured to read needed data, if the needed data is not found in the local memory storage, from a remote node and store the needed data, wherein the remote node is one of the plurality of nodes.

### CROSS-REFERENCE TO RELATED APPLICATIONS

This application claims the benefit of Korean Patent Application No. 10-2014-0054930, filed on May 8, 2014, Korean Patent Application No. 10-2014-0170740, filed on Dec. 2, 2014, and Korean Patent Application No. 10-2015-0056000, filed on Apr. 21, 2015, in the Korean Intellectual Property Office, the disclosures of which are incorporated herein in their entireties by reference.

### BACKGROUND

1. Field

One or more exemplary embodiments relate to a database management system (DBMS), and more particularly, to a hybrid DBMS that supports a function of immediately using data while the hybrid DBMS is starting up, even before all data is loaded to a memory device.

2. Description of the Related Art

According to a database management system (DBMS) of the related art, when an in-memory DBMS starts operating, a memory table and a memory index may be used after all data in the memory table and the memory index is loaded to a main memory. In this case, if the amount of data or a size of the memory index is large, it may be inconvenient to wait for a long period of time to use the memory table and the memory index after the DBMS starts operating.

### SUMMARY

One or more exemplary embodiments include a system that addresses the problem that, when a conventional DBMS is starting up, it may be inconvenient to use data or data may not be used before all data is to a memory device. Additionally, necessary data may be selectively read and used by querying data to remote nodes that share a shared storage.

Additional aspects will be set forth in part in the description which follows and, in part, will be apparent from the description, or may be learned by practice of the presented embodiments.

According to one or more exemplary embodiments, a memory cluster system includes: a shared storage; a plurality of nodes configured to share the shared storage; and a controller configured to allocate data to be loaded by each node to each main memory of each of the plurality of nodes and used by a memory pointer when a database management system (DBMS) is starting up, from among data in the shared storage, to a main memory of each of the plurality of nodes based on a capacity of the main memory of each of the plurality of nodes, wherein the main memory of each of the plurality of nodes includes: a local memory storage configured to load data from all memory tables and all memory indexes to the main memory of each of the plurality of nodes when the DBMS is starting up; and a remote memory storage configured to read needed data, if the needed data is not found in the local memory storage, from a remote node and store the needed data, wherein the remote node is one of the plurality of nodes.

The local memory storage may be configured to load the data in units of tables if the data in the shared storage is in the form of a general table and load data in units of table partitions if the data in the shared storage is in the form of a partitioned table.

The remote memory storage may read and load the needed data in units of data pages.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a block diagram of a memory cluster system according to an exemplary embodiment;

FIG. 2 illustrates an internal block diagram of a loading part of a node used in the memory cluster system according to an exemplary embodiment;

FIG. 3 illustrates is an internal block diagram of a main memory part of a node according to an exemplary embodiment;

FIG. 4 illustrates an example of a memory table and a memory index used in a data loader, according to an exemplary embodiment; and

FIG. 5 illustrates an example of a mapping table generated by a memory address mapper, according to an exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

Hereinafter, exemplary embodiments will be described in detail with reference to the attached drawings. Like reference numerals in the drawings denote like elements, and thus their description will be omitted.

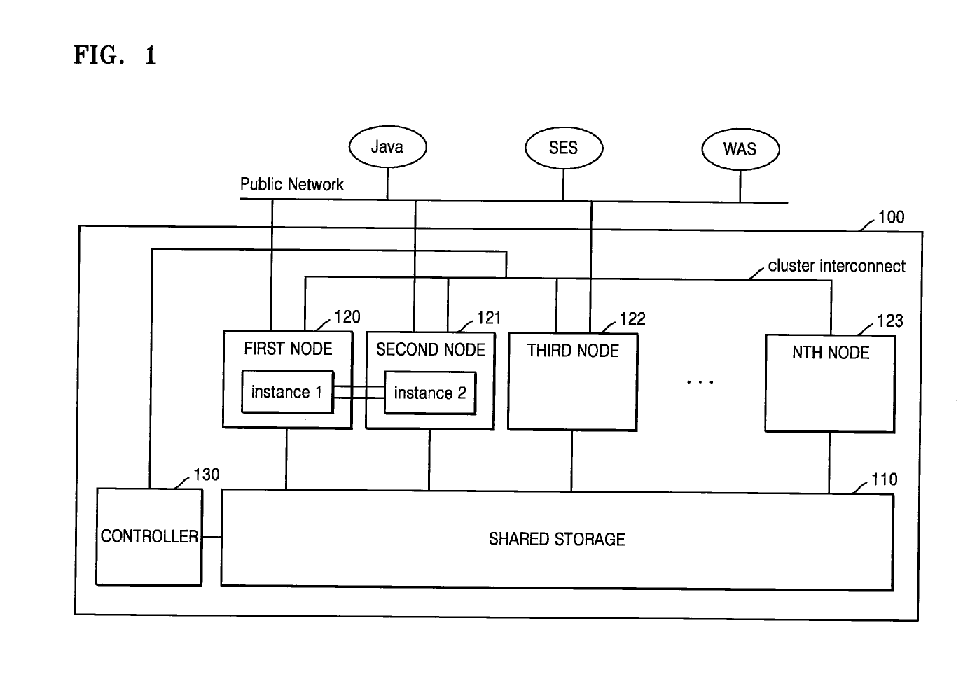

FIG. 1 illustrates a block diagram of a memory cluster system 100 according to an exemplary embodiment.

The memory cluster system may include a shared storage 110, a plurality of nodes 120 through 123 that share the shared storage 110, and a controller 130.

Each of the plurality of nodes 120 through 123 may determine data stored in main memory of other nodes from among the plurality of nodes 120 through 123 and a usage capacity of the main memory of the other nodes by performing broadcast communication with the other nodes.

The controller 130 allocates data to be loaded by each node to each main memory of each of the plurality of nodes 120 through 123 and used by a memory pointer when a database management system (DBMS) is starting up, from among data in the shared storage 110, to each of the plurality of nodes 120 through 123 according to a capacity of each main memory of the plurality of nodes 120 through 123.

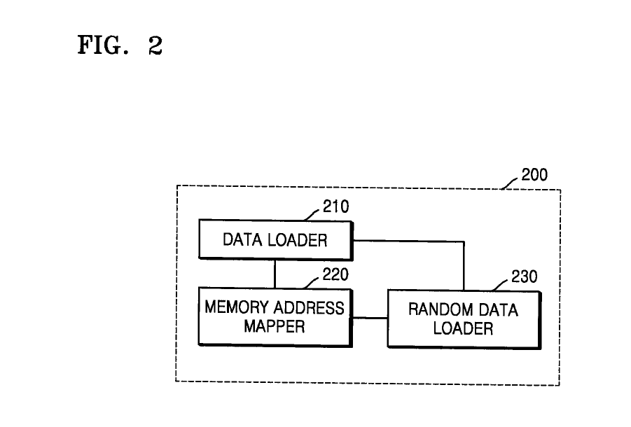

FIG. 2 illustrates an internal block diagram of a node 200 used in the memory cluster system 100 according to an exemplary embodiment.

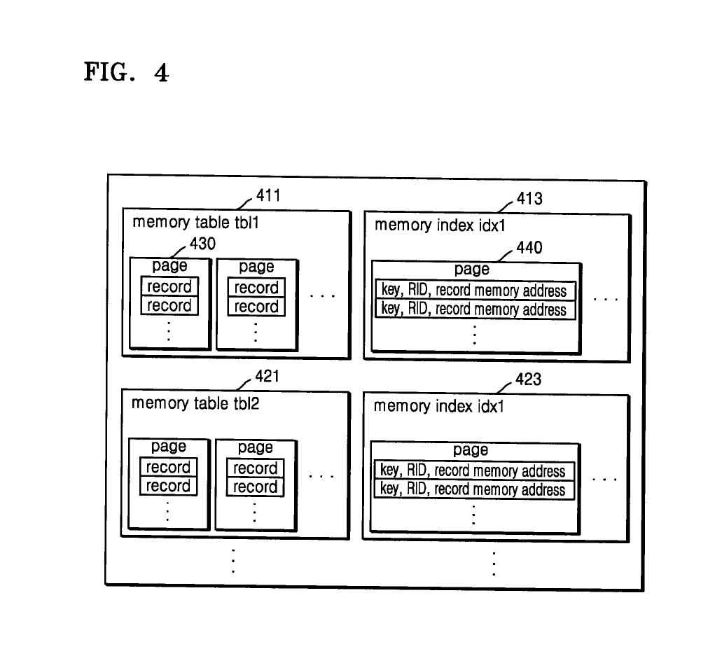

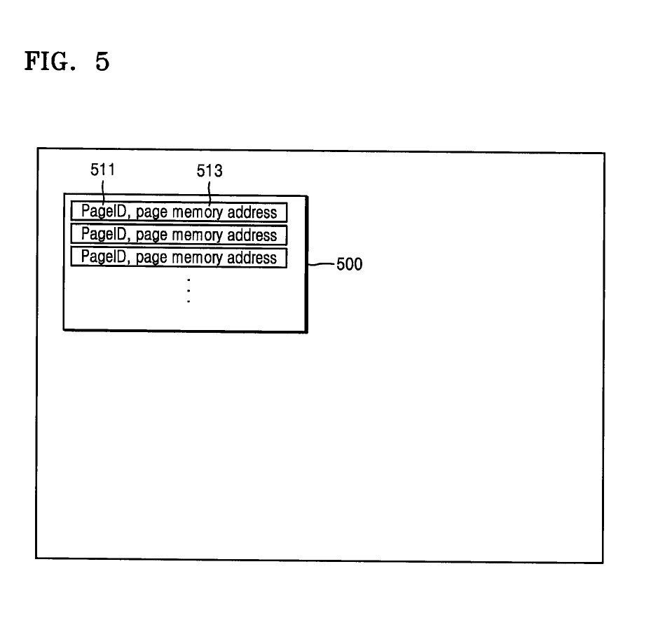

The node 200 may include a data loader 210, a memory address mapper 220, and a random data loader 230. Each element is described with reference to FIGS. 4 and 5 as follows. FIG. 4 illustrates an example of a memory table and a memory index used in the data loader 210. FIG. 5 illustrates an example of a mapping table generated by the memory address mapper 220.

When the DBMS is starting up, the data loader 210 loads all data to each of the plurality of nodes 120 through 123 shown in FIG. 1 in units of objects. Additionally, if data 0001 through data 3000 is to be moved from the shared storage 110 to one of a main memory of a node, the data loader 210 may sequentially split the data 0001 through the data 3000 into data 0001 through data 1000, data 1001 through data 2000, and data 2001 through data 3000 and move the split data 0001 through data 3000 in parallel to the main memory.

Referring to FIGS. 4 and 5, while the data loader 210 is loading data from the shared storage 110 to the main memory of each node, the memory address mapper 120 generates a mapping table 500 (shown in FIG. 5) in the memory of each node by mapping a page identification (ID) 511 (shown in FIG. 5) for identifying respective pages 440 and 450 (shown in FIG. 4) constituting memory tables 411 and 412 (shown in FIG. 4) and memory indexes 413 and 423 (shown in FIG. 4) to a memory address 513 (shown in FIG. 5) of the respective pages 440 and 450.

In this case, a node having the memory indexes 413 and 423 shown in FIG. 4 is determined according to a node having the memory tables 411 and 421 (shown in FIG. 4) respectively corresponding to the memory indexes 413 and 423. Additionally, a memory partition index is determined according to a node having a memory table partition corresponding to the memory partition index. For example, if a table A is loaded to a first node, indexes index1_A and index2_B for the table A are also loaded to the first node.

When the DBMS starts operating, the mapping table 500 shown in FIG. 5 includes only information about the page ID 511 shown in FIG. 5, and a memory address 513 corresponding to the page ID 511, which is shown in FIG. 5, is empty.

The controller sets a node to which data to be allocated by setting an amount of the data to be allocated according to a capacity of the main memory of each node.

When the DBMS is starting up, if the data loader 210 loads data to the main memory of each node, the memory address mapper 220 generates a mapping table by mapping the loaded data to a memory address where the loaded data is stored.

When the DBMS is starting up, if a request for accessing particular data before the data loader 210 shown in FIG. 2 finishes loading data to the main memory of each node is generated, each node searches for a memory address of the data to be accessed with reference to the mapping table.

If the memory address is not found, the random data loader 230 accesses the data to be accessed from the shared storage and loads the accessed data to the main memory of each node. Then, the random data loader 230 adds the accessed data and a memory address, where the accessed data is loaded, to the mapping table 500 shown in FIG. 5, and thus, updates the mapping table 500.

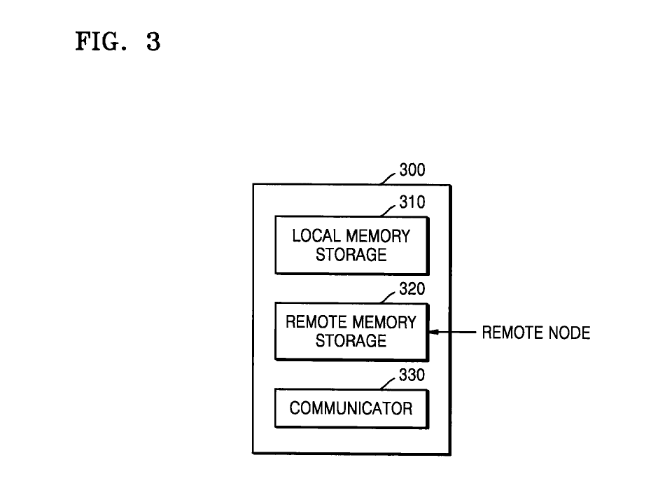

FIG. 3 illustrates an internal block diagram of a node 300 according to an exemplary embodiment. The node 300 may include main memories 310 and 320 and a communicator 330. The main memories 310 and 320 are respectively a local memory storage 310 and a remote memory storage 320.

When the DBMS is starting up, the local memory storage 310 loads data in all memory tables and all memory indexes to a main memory of each node in units of objects. If data in a shared storage is a non-partitioned table, the local memory storage 310 loads data to the memory in units of tables. If data in a shared storage is stored in a partitioned table, the local memory storage 310 loads data to the main memory in units of table partitions.

Each node 300 employs the remote memory storage 320 to query and modify data loaded to a remote node. If data loaded to a local memory storage of the remote node is needed, the remote memory storage 320 reads only the needed data from the local memory storage of the remote node and loads the data to the remote memory storage 320.

Each node modifies remote data, obtained from the remote node, in the remote memory storage 320 of each node. For this, the node which has the remote memory storage 320 may allocate a permanent storage area for redo logging.

According to an exemplary embodiment, if a client using the memory cluster system 100 requests a structured query language (SQL), the client requests the SQL statement from a node to which data for processing the requested SQL has been allocated via the controller 130 shown in FIG. 1. However, if all data has not been allocated to a particular node, the data may be requested from a remote node, and thus, the data may be employed.

According to an exemplary embodiment, a memory cluster system may allocate and load data to a plurality of nodes and query and use data stored in a remote node.

According to an exemplary embodiment, the memory cluster system may immediately use data even before all data in memory tables and memory indexes is loaded to a main memory.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.
< [symbol] >
[symbol] 1
130 CONTROLLER ( [symbol] [symbol] 130 [symbol] .)
120 FIRST NODE
121 SECOND NODE
122 THIRD NODE
123 NTH NODE
110 SHARED STORAGE
[symbol] 2
210 DATA LOADER
220 MEMORY ADDRESS MAPPER
230 RANDOM DATA LOADER
[symbol] 3
310 LOCAL MEMORY STORAGE
320 REMOTE MEMORY STORAGE
330 COMMUNICATOR
[symbol] REMOTE NODE

What is claimed is:

1. A memory cluster system, comprising:
a shared storage;
a plurality of nodes configured to share the shared storage; and
a controller configured to allocate data to be loaded by each node to each main memory of each of the plurality of nodes and used by a memory pointer when a database management system (DBMS) is starting up, from among data in the shared storage, to a main memory of each of the plurality of nodes based on a capacity of the main memory of each of the plurality of nodes,
wherein the main memory of each of the plurality of nodes comprises:
a local memory storage configured to load data from all memory tables and all memory indexes to the main memory of each of the plurality of nodes when the DBMS is starting up; and
a remote memory storage configured to read needed data, if the needed data is not found in the local memory storage, from a remote node and store the needed data, wherein the remote node is one of the plurality of nodes.

2. The memory cluster system of claim 1, wherein the local memory storage is configured to load the data in units of tables if the data in the shared storage is in the form of a non-partitioned table and load data in units of table partitions if the data in the shared storage is in the form of a partitioned table.

3. The memory cluster system of claim 1, wherein the remote memory storage reads and loads the needed data in units of data pages.

4. The memory cluster system of claim 1, wherein each of the plurality of nodes determines data stored in a local memory storage of each of the other nodes from among the plurality of nodes and a usage capacity of the local memory storage by performing broadcast communication with the other nodes.

5. The memory cluster system of claim 1, wherein the controller is configured to allocate data to each local memory storage of each of the plurality of nodes based on a capacity of each local memory storage of each of the plurality of nodes.

6. The memory cluster system of claim 1, wherein the controller is configured to determine a node, from among the plurality of nodes, to which the allocated data is to be stored, and
each node is further configured to generate a mapping table by mapping the allocated data to a memory address where the loaded data is stored, wherein each of the plurality of nodes searches for a memory address of data that is to be accessed by using the mapping table.

7. The memory cluster system of claim 6, wherein, if each of the plurality of nodes is configured to access the allocated data before the loading of the allocated data to the main memory of the determined node is completed when the DBMS is starting up, to search for a memory address of the data that is to be accessed, with reference to the mapping table, if the memory address is not found, access the data that is to be accessed from the shared storage and load the accessed data to each local memory storage, and add the accessed data and a memory address to which the called data is loaded to the mapping table.

8. The memory cluster system of claim 6, wherein a node having a memory index is determined according to a node having a memory table indexed by the memory index.

9. The memory cluster system of claim 8, wherein a node having a memory partition index is determined according to a node having a memory table partition corresponding to the memory partition index.
